(19) United States
(12) Patent Application Publication
(10) Pub. No.: US 2019/0146854 A1
(43) Pub. Date: May 16, 2019

(54) Application Programming Interface Mapping and Generation

(71) Applicant: Microsoft Technology Licensing, LLC, Redmond, WA (US)

(72) Inventors: Gareth Jones, Redmond, WA (US); Sriram Dhanasekaran, Redmond, WA (US); Yi Li, Redmond, WA (US); Kevin Wiggen, Redmond, WA (US)

(21) Appl. No.: 15/856,864

(22) Filed: Dec. 28, 2017

Related U.S. Application Data
(60) Provisional application No. 62/585,356, filed on Nov. 13, 2017.

(51) Int. Cl. G06F 9/54

(52) U.S. Cl. CPC G06F 9/54

(57) ABSTRACT

Non-limiting examples of the present disclosure describe mapping between vertical and horizontal application programming interface (API) construct data. An exemplary mapping is utilized to automatically generate and implement an API for a developer without the need for the developer to code a full implementation of the API. In one example, an API for implementation is a vertical API, where the vertical API is being integrated to work within the framework of a horizontal API. Vertical API construct data is accessed, where the vertical API construct data is domain-specific. The vertical API construct data is mapped, in a same data layer, with horizontal API construct data for a horizontal API. A vertical API may be automatically implemented for a developer based on the mapping of the vertical API construct data and the horizontal API construct data, without requiring the developer to code the vertical API for integration into the horizontal API.

### CROSS-REFERENCE TO RELATED APPLICATIONS

This application claims priority to U.S. Provisional Patent Application No. 62/585,356, entitled “APPLICATION PROGRAMMING INTERFACE MAPPING AND GENERATION”, filed on Nov. 13, 2017, which is incorporated by reference herein in its entirety.

### BACKGROUND

Complete implementations of industry-centric domain models have been implemented for many different types of industries. However, such domain models are expensive to build and maintain. Further issues arise when an industry-specific model is configured to interface with a technology platform such as Microsoft®, Google®, Apple®, etc., that provides platform services. Developers may seek to develop application programming interfaces (APIs) that have very close correspondence to their problem domain. However, generating a cognitive translation in usage from a specific domain to an API of a platform service is draining from a productivity standpoint but also problematic from a processing efficiency standpoint. Changes to parameter data associated with a domain or platform can result in implementation issues for a domain API, causing operability and scalability issues.

Commonly, developers wishing to implement a domain-specific API over an API for a platform service are required to generate a separate data layer (or layers) for coding of domain-specific data that can interface with the API of the platform service. For instance, a data wrapper may be used to enable a domain-specific API to run successfully over an API of a platform service. However, even before implementation, developers are required to code such data wrappers, which requires the developer to have knowledge and understanding of specific parameters and attributes used by the API of the platform service. Furthermore, as additional layers of data (e.g. data wrappers) are added, complexity increases and scalability decreases. For instance, if changes occur at the API layer for the platform service, this may cause implementation issues for a domain-specific API, where a domain-specific API may no longer be configured to integrate with the API for the platform service without requiring update to the code of the domain-specific API.

### SUMMARY

Non-limiting examples of the present disclosure describe mapping between vertical and horizontal application programming interface (API) construct data, where a lightweight domain-specific adaptation is created that enables a vertical API to be generated and implemented over an underlying product while isolating developers from the implementation details of an underlying product. An exemplary mapping may be utilized to automatically generate and implement an API for a developer without the need for the developer to code a full implementation of the API. Processing operations described herein may apply to different API generation examples including generation of a vertical API or a horizontal API. For instance, a vertical API may be generated for integration within a framework of a horizontal API.

Vertical API construct data may be created and accessed, where the vertical API construct data is configured to be domain-specific. The vertical API construct data may be mapped, in a same data layer, with horizontal API construct data for a horizontal API. For instance, a single data layer may be utilized to map vertical and horizontal APIs as compared to examples where code for vertical APIs are written into a separate data layers (e.g. data wrappers) from that of underlying application/service (e.g. horizontal API). A vertical API may be automatically implemented for a developer based on the mapping of the vertical API construct data and the horizontal API construct data, without requiring the developer to code the vertical API for integration into the horizontal API.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an exemplary method related to mapping between a vertical programming interface (API) and a horizontal API with which aspects of the present disclosure may be practiced.

FIG. 2 illustrates an exemplary method related to update of a mapping between vertical and horizontal APIs with which aspects of the present disclosure may be practiced.

FIG. 3 is a block diagram illustrating an example of a computing device with which aspects of the present disclosure may be practiced.

FIGS. 4A and 4B are simplified block diagrams of a mobile computing device with which aspects of the present disclosure may be practiced.

FIG. 5 is a simplified block diagram of a distributed computing system in which aspects of the present disclosure may be practiced.

### DETAILED DESCRIPTION

Non-limiting examples of the present disclosure describe mapping between vertical and horizontal application programming interface (API) construct data, where a lightweight domain-specific adaptation is created that enables a vertical API to be implemented over an underlying product while isolating developers from the implementation details of an underlying product. An exemplary mapping may be utilized to automatically generate and implement an API for a developer without the need for the developer to code a full implementation of the API.

Processing operations described herein may apply to different API implementation examples including generation of a vertical API or a horizontal API. For instance, a vertical API may be generated for integration within a framework of a horizontal API. An exemplary vertical API is configured for a specific domain/industry. An exemplary horizontal API is a platform service that accessed by specific domains (i.e. through vertical APIs). An example of a platform service is a directory service, where domains and/or sub-domains can be used to define namespace for network services. Platform services are not limited to only directory services and may extend to any examples of software as a service or infrastructure as a service, among other examples. As an illustrative example, a vertical API may be configured for educational software to run over a directory service, where a result of the vertical executing over the directory service enables students and teachers to manage classroom rosters through an application/service.

Vertical API construct data may be created and accessed, where the vertical API construct data is configured to be domain-specific. The vertical API construct data may be mapped, in a same data layer, with horizontal API construct data for a horizontal API. For instance, a single data layer may be utilized to map vertical and horizontal APIs as compared to examples where code for vertical APIs are written into a separate data layers (e.g. data wrappers) from that of underlying application/service (e.g. horizontal API). In the past, multiple data wrappers may be used to correspond API constructs over another API for an application/service. However, such as solution is not as scalable (e.g. when new domains are to be added a new wrapper is typically created) and requires developers to specifically code the API within the parameters of the existing application/service as well as constantly stay on top of updates to API constructs to maintain coherence.

An exemplary mapping between API constructs provides selective transformation and representation of horizontal API constructs as vertical constructs. The mapping is bi-directional, where a two-way mapping system is created between vertical API construct data and horizontal API construct data. Mapping may generate a plurality of transparent data containers that are specific to correlate data objects and attributes between vertical API construct data and horizontal API construct data. An exemplary data layer used for mapping may comprise the plurality of transparent data containers that group construct data (e.g. data objects, parameters, attributes, etc.) for a horizontal API with parameters (e.g. vertical API construct data) for generation of a domain-specific vertical API. Transparent data containers are utilized to create an associated transformation of sub-elements within a horizontal API to ensure a high-quality API design surface for construction and implementation of a vertical API on top of a horizontal API. Generation of exemplary transparent data containers may comprise one or more of: data conversion and data coercion of API construct data, for example, to manipulate entity types for mapping between vertical API construct data and horizontal API construct data. In many cases, vertical API construct data may comprise customized parameters that may be a different data type/entity type from parameters associated with the horizontal API construct data.

A vertical API may be automatically implemented for a developer based on the mapping of the vertical API construct data and the horizontal API construct data. The vertical API may be generated (and implemented) without requiring the developer to code an entire implementation of the vertical API. Examples described herein may further comprise implementing the vertical API across the platform service/services of the horizontal API, where the vertical API may interface with and run in conjunction with the horizontal API. One or more domains/sub-domains associated with the vertical API may be surfaced in a representation of the horizontal API. For instance, in an example where the vertical API is configured as an educational domain/service, execution of the API may surface a domain where users can manage educational classes online.

Accordingly, the present disclosure provides a plurality of technical advantages including but not limited to: automated generation and implementation of a lightweight two-way mapping system between vertical and horizontal application programming interface (API) construct data that can be used to generated and implement an API, increased processing efficiency for computing devices and developers through automated generation of an API (e.g. vertical API) without the need for the developer to code a full implementation of the API, ability for developers to generate a domain-specific API without extensive knowledge of construct data for a horizontal API through selective transformation and representation of horizontal API constructs as vertical API constructs, more efficient management of computing resources where an exemplary mapping between API construct data is usable to efficiently scale domain-specific APIs over a platform service, for example, through automated data conversion and/or coercion of horizontal API construct data, and improved user interaction (e.g. developer) with exemplary platform services, among other examples.

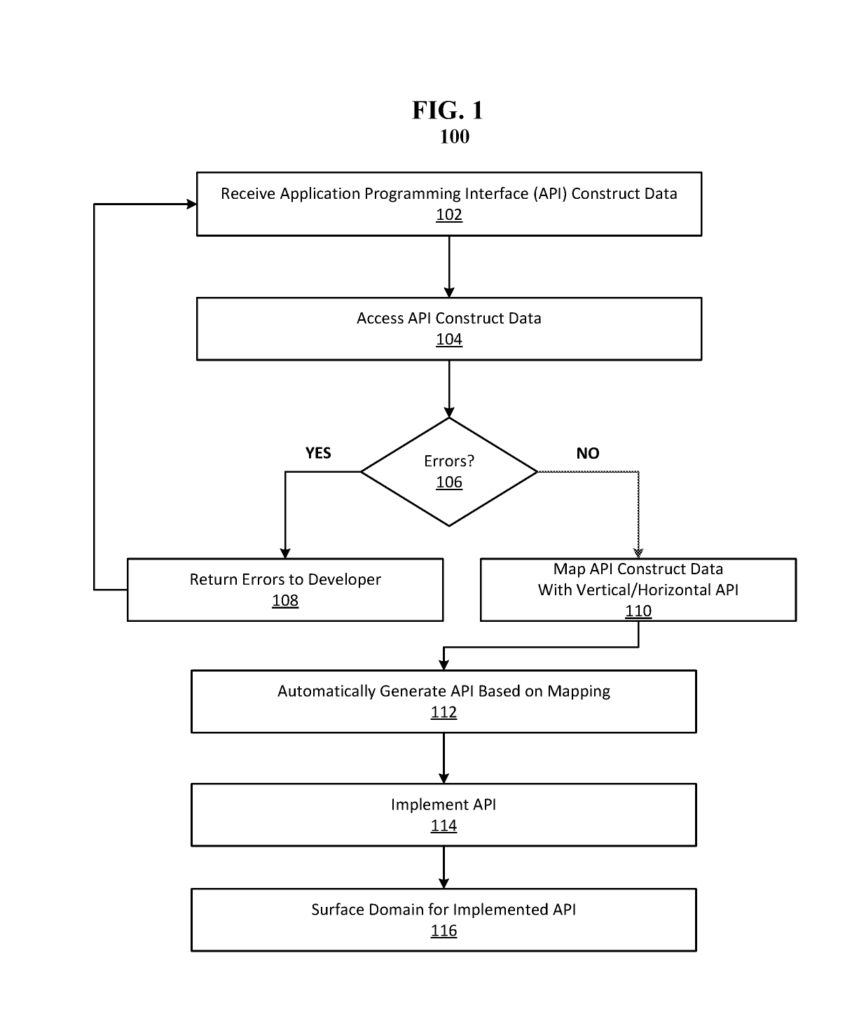

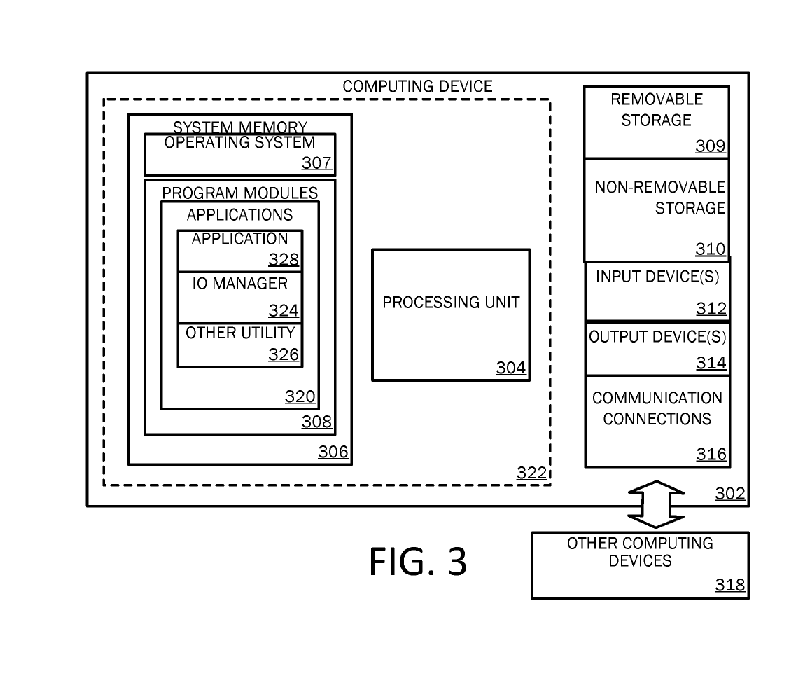

FIG. 1 illustrates an exemplary method 100 related to mapping between a vertical programming interface (API) and a horizontal API with which aspects of the present disclosure may be practiced. As an example, method 100 may be executed by an exemplary processing device and/or system such as those shown in FIGS. 3-5. In examples, method 100 may execute on a device comprising at least one processor configured to store and execute operations, programs or instructions as described herein. Operations performed in method 100 may correspond to operations executed by a system and/or service that execute computer programs, application programming interfaces (APIs), computer-generated modeling, neural networks or machine-learning processing, among other examples. As an example, processing operations executed in method 100 may be performed by one or more hardware components. In another example, processing operations executed in method 100 may be performed by one or more software components. In some examples, processing operations described in method 100 may be executed by one or more applications/services associated with a web service that has access to a plurality of application/services, devices, knowledge resources (including semantic data structures, entity models), etc. Processing operations described in method 100 may be implemented by one or more components connected over a distributed network.

Method 100 begins at processing operation 102, where application programming interface (API) construct data is received. An API enables applications/services to interface or communicate with each other. An exemplary API defines one or more specifications that comprise a set of subroutine definitions (e.g. libraries), protocols and tools for building application software. An exemplary specification of an API may take many forms but may comprise data for routines, data structures, object classes, variables and remote calls, among other examples. For example, a developer wishing to generate a vertical API to integrate with a horizontal API (e.g. one or more platform services) may provide vertical API construct data.

Processing operations described herein may apply to different API generation examples including generation of a vertical API or a horizontal API. For instance, a vertical API may be generated for integration within a framework of a horizontal API. An exemplary vertical API is configured for a specific domain/industry. An exemplary horizontal API is a platform service that accessed by specific domains (i.e. through vertical APIs). An example of a platform service is a directory service, where domains and/or sub-domains can be used to define namespace for network services. Platform services are not limited to only directory services and may extend to any examples of software as a service or infrastructure as a service, among other examples. As one example, a vertical API may be configured for educational software to run over a directory service, where a result of the vertical executing over the directory service enables students and teachers to manage classes through an application/service.

Processing operation 102 may comprise a developer uploading vertical API construct data to an application/service for generation of an exemplary mapping between a vertical API and a horizontal API. Vertical API construct data may comprise parameters and/or data objects/types that are used for integration of a domain-specific data over a platform service. Exemplary parameters may be dependent on the type of domain that the developer is working in and creation of such parameters is known to one skilled in the field of art. Parameters may be customized for a specific industry and may vary across different vertical API construct data. Exemplary mapping operations described herein execute processing operations to identify the customized parameters of vertical API construct data and associate them with existing constructs in horizontal API construct data. As an example, vertical API construct data may be as an index file that comprises parameter data for defining a specific domain that may be integrated over a platform service. An exemplary index file may comprise customized parameters that define domain-specific data objects for integration with a platform service. Processing operations related to generation of exemplary index files are known to one skilled in the art. For example, a developer may be working with an index file that is created our uploaded to a service for management of API data. As an example, an exemplary service for management of APIs to integrate with a platform service may be Microsoft® Azure®, Active Directory® or other similar directory services.

Flow of method 100 may proceed to processing operation 104, where API construct data is accessed by an exemplary platform service. For instance, processing operation 104 may comprise accessing an exemplary index file that comprises vertical API construct data (parameters, data objects, attributes, etc.) defining a domain for generation of a vertical API.

At decision operation 106, the accessed API construct data is evaluated. Evaluation of the API construct data may yield a determination as to whether or not the API construct data comprises any errors that may exist before the API construct data is mapped to other existing API construct data. For example, certain parameters may not be properly defined or may be left blank, values not identified, not recognized by API construct data for a horizontal API, etc. In some examples, an exemplary platform service may generate documentation to assist developers with customization of parameters so to minimize mapping errors at run-time when API construct data (e.g. vertical API construct data) is to be mapped to other existing API construct data (e.g. horizontal API construct data). Error detection for evaluation of API construct data is known to one skilled in the art.

In examples where an error is determined in an exemplary index file, flow of decision operation 106 branches YES and processing of method 100 proceeds to processing operation 108. At processing operation 108, errors are returned to a developer for correction. In such an example, flow of method 100 may return back to processing operation 102, where a develop may re-submit API construct data for subsequent re-evaluation. In examples where there are no errors detected in an exemplary index file, flow of decision operation 106 branches NO and processing of method 100 proceeds to processing operation 110.

At processing operation 110, the API construct data is mapped with existing API construct data to generate an exemplary mapping between vertical API construct data and horizontal API construct data. An exemplary data model may be utilized to manage generation of exemplary mappings between API construct data. In some instances, the data model may be the same data model that is used to generate an implementation of API. However, in other examples, separate data models may be utilized to generate a mapping and an implementation of an API. An exemplary data model for mapping may be trained (e.g. learned data model) that can be configured to recognize specific parameters, data object types, parallels/relationships between data objects, etc., so as to map vertical API construct data with horizontal API construct data. An exemplary mapping is bi-directional, where a two-way mapping system is created between vertical API construct data and horizontal API construct data. The vertical API construct data may be mapped, in a same data layer, with horizontal API construct data for a horizontal API. For instance, a single data layer may be utilized to map vertical and horizontal APIs as compared to examples where code for vertical APIs are written into a separate data layers (e.g. data wrappers) from that of underlying application/service (e.g. horizontal API). As an example, the single data layer is a data layer for the horizontal API construct data without requiring API construct data to be correlated with data wrappers for domain-specific API data.

An exemplary mapping (generated in processing operation 110) provides selective transformation and representation of horizontal API constructs as vertical constructs. One or more data learning models may be trained to evaluate the vertical API construct data and correlate that with the horizontal API construct data. Mapping (processing operation 110) may comprise processing operations for generation of a plurality of transparent data containers that are specific to correlate data objects and attributes between vertical API construct data and horizontal API construct data. An exemplary data layer used for mapping may comprise the plurality of transparent data containers that group construct data (e.g. data objects, parameters, attributes, etc.) for a horizontal API with parameters (e.g. vertical API construct data) for generation of a domain-specific vertical API. Transparent data containers are generated to create an associated transformation of sub-elements within a horizontal API to ensure a high-quality API design surface for construction and implementation of a vertical API on top of a horizontal API. Generation of exemplary transparent data containers may comprise one or more of: data conversion and data coercion of API construct data, for example, to manipulate entity types for mapping between vertical API construct data and horizontal API construct data. In many cases, vertical API construct data may comprise customized parameters that may be a different data type/entity type from parameters associated with the horizontal API construct data. The transparent data containers may be specific to attribute mapping between vertical API construct data and horizontal API construct data. This enables a mapping to be lightweight, where changes to a parameter of either vertical/horizontal API construct data can be specifically tied to the respective other of the vertical/horizontal API construct data. Such processing also makes an exemplary mapping scalable when updates occur including adding of additional application/services to a platform service. As an example, one or more transparent data containers are written into a data layer of the horizontal API construct data.

Flow of method 100 may proceed to processing operation 112. At processing operation 112, an exemplary API is generated based on the created mapping. For example, processing operation 112 may comprise automatically generating the vertical API for a developer based on the mapping of the vertical API construct data and the horizontal API construct data. The vertical API may be generated without requiring the developer to code an entire implementation of the vertical API. As an example, a trained data model (e.g. learning model) may be utilized evaluate and parse the created mapping to automatically generate an exemplary API. Developers of the platform service may manage update and training of the data model as well as management of horizontal API construct data, generated mappings, and scalability of exemplary platform services.

Flow of method 100 may proceed to processing operation 114, where a generated API may be implemented across the platform service/services. In one example, processing operation 114 may comprise implementing the vertical API across the platform service/services of the horizontal API, where the vertical API may interface with and run in conjunction with the horizontal API. In actual implementation, processing operations 112 and 114 may be executed as a single processing operation. However, in some examples, this may occur as multiple processing operations.

At processing operation 116, a domain for an implemented API may be surfaced. For instance, one or more domains/sub-domains associated with the vertical API. In an example where the vertical API is configured as an educational domain/service, execution of the API may surface a domain where users can manage educational classes online. Domain configuration data can be accessed through an exemplary platform service (e.g. directory service). Domain structure may also be modifiable through the exemplary platform service.

Examples described herein may occur in a network environment where a service (or multiple services) are exposed to enable generation and implementation of an API that may be integrated within a data structure associated with another API. In service examples, one or more computing devices (e.g. servers) may be configured for execution of the processing operations described herein. The present disclosure is intended to be applicable to any type of network service-based examples without departing from the spirit of the present disclosure.

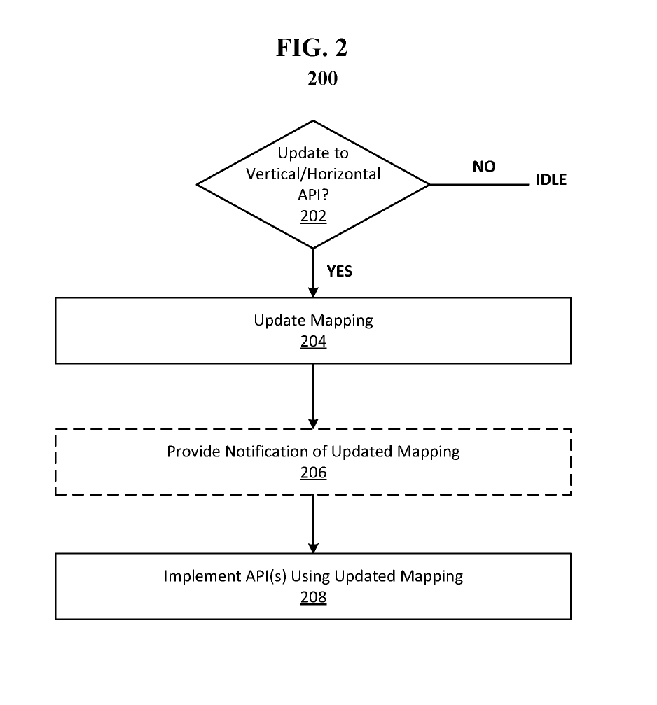

FIG. 2 illustrates an exemplary method 200 related to update of a mapping between vertical and horizontal APIs with which aspects of the present disclosure may be practiced. As an example, method 200 may be executed by an exemplary processing device and/or system such as those shown in FIGS. 3-5. In examples, method 200 may execute on a device comprising at least one processor configured to store and execute operations, programs or instructions as described herein. Operations performed in method 200 may correspond to operations executed by a system and/or service that execute computer programs, application programming interfaces (APIs), computer-generated modeling, neural networks or machine-learning processing, among other examples. As an example, processing operations executed in method 200 may be performed by one or more hardware components. In another example, processing operations executed in method 200 may be performed by one or more software components. In some examples, processing operations described in method 200 may be executed by one or more applications/services associated with a web service that has access to a plurality of application/services, devices, knowledge resources (including semantic data structures, entity models), etc. Processing operations described in method 100 may be implemented by one or more components connected over a distributed network.

Flow of method 200 begins at decision operation 202, where it is determined whether there is an update to be made to a vertical API and/or a horizontal API. Among other examples, a parameter may be modified within the vertical or horizontal API construct data or the horizontal API may be scaled to add/remove application/services. In examples where no update occurs, flow of decision operation 202 branches NO and processing of method 200 remains idle until subsequent update is to occur. In examples where an update occurs to API construct data, flow of decision operation 202 branches YES and processing of method 200 proceeds to processing operation 204.

At processing operation 204, an exemplary mapping between vertical API construct data and horizontal API construct is updated. Generation of an exemplary mapping is described in the foregoing description of method 100 (FIG. 1). As identified in the foregoing, an exemplary mapping is bi-directional, where a two-way mapping system is created between vertical API construct data and horizontal API construct data. Update (processing operation 204) of the mapping may comprise update of one or more of the plurality of transparent data containers that are specific to correlate data objects and attributes between vertical API construct data and horizontal API construct data. For instance, an exemplary transparent data container may be re-mapped (e.g. modified, added, removed, etc.) based on changes made to API construct data (or the introduction/removal of other API construct data). As referenced in the foregoing, an exemplary data model may be utilized to manage generation of exemplary mappings between API construct data.

In some example, flow of method 200 may proceed to processing operation 206, where notification of an updated mapping may be provided. As an example, a notification of update to a mapping may be provided to a developer. This may assist developers with staying up to date with modifications made to an exemplary horizontal API. In some examples, an exemplary notification may be provided through a user interface of an exemplary platform service. In other examples, a notification may be configured to be provided through other modalities (e.g. email, messaging, phone call, media object, etc.) based on an update to an exemplary mapping.

Flow of method 200 may proceed to processing operation 208, where an exemplary API is implemented using the updated mapping.

FIGS. 3-5 and the associated descriptions provide a discussion of a variety of operating environments in which examples of the invention may be practiced. However, the devices and systems illustrated and discussed with respect to FIGS. 3-5 are for purposes of example and illustration and are not limiting of a vast number of computing device configurations that may be utilized for practicing examples of the invention, described herein.

FIG. 3 is a block diagram illustrating physical components of a computing device 302, for example a mobile processing device, with which examples of the present disclosure may be practiced. Among other examples, computing device 302 may be an exemplary computing device configured for mapping between a vertical programming interface (API) and a horizontal API and related processing operations (including automated generation of an API) as described herein. In one example, computing device 302 may be a server device that is configured to work with a service that executes the processing operations described herein.

In a basic configuration, the computing device 302 may include at least one processing unit 304 and a system memory 306. Depending on the configuration and type of computing device, the system memory 306 may comprise, but is not limited to, volatile storage (e.g., random access memory), non-volatile storage (e.g., read-only memory), flash memory, or any combination of such memories. The system memory 306 may include an operating system 307 and one or more program modules 308 suitable for running software programs/modules 320 such as IO manager 324, other utility 326 and application 328. As examples, system memory 306 may store instructions for execution. Other examples of system memory 306 may store data associated with applications. The operating system 307, for example, may be suitable for controlling the operation of the computing device 302. Furthermore, examples of the invention may be practiced in conjunction with a graphics library, other operating systems, or any other application program and is not limited to any particular application or system. This basic configuration is illustrated in FIG. 3 by those components within a dashed line 322. The computing device 302 may have additional features or functionality. For example, the computing device 302 may also include additional data storage devices (removable and/or non-removable) such as, for example, magnetic disks, optical disks, or tape. Such additional storage is illustrated in FIG. 3 by a removable storage device 309 and a non-removable storage device 310.

As stated above, a number of program modules and data files may be stored in the system memory 306. While executing on the processing unit 304, program modules 308 (e.g., Input/Output (I/O) manager 324, other utility 326 and application 328) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 3 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 402 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 302 may also have one or more input device(s) 312 such as a keyboard, a mouse, a pen, a sound input device, a device for voice input/recognition, a touch input device, etc. The output device(s) 314 such as a display, speakers, a printer, etc. may also be included. The aforementioned devices are examples and others may be used. The computing device 302 may include one or more communication connections 316 allowing communications with other computing devices 318. Examples of suitable communication connections 316 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 306, the removable storage device 309, and the non-removable storage device 310 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 302. Any such computer storage media may be part of the computing device 302. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

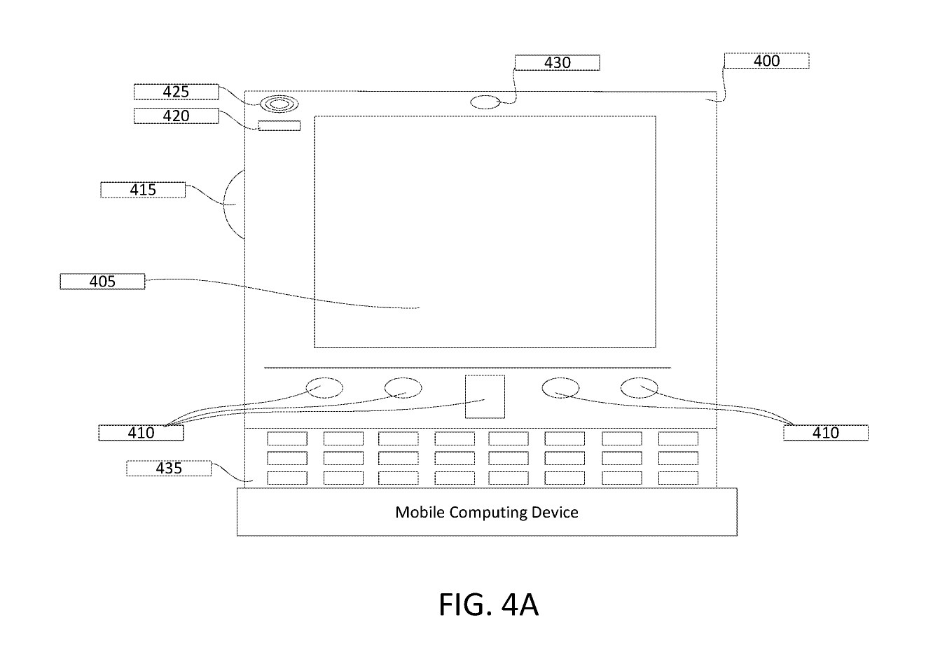

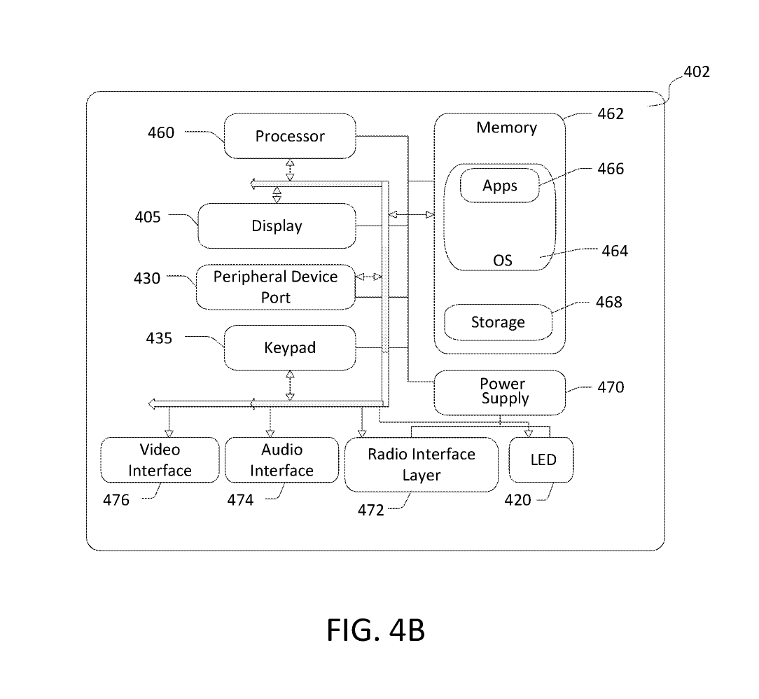

FIGS. 4A and 4B illustrate a mobile computing device 400, for example, a mobile telephone, a smart phone, a personal data assistant, a tablet personal computer, a phablet, a slate, a laptop computer, and the like, with which examples of the invention may be practiced. Mobile computing device 400 may be an exemplary computing device configured for mapping between a vertical programming interface (API) and a horizontal API and related processing operations (including automated generation of an API) as described herein. Application command control may be provided for applications executing on a computing device such as mobile computing device 400. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 4A, one example of a mobile computing device 400 for implementing the examples is illustrated. In a basic configuration, the mobile computing device 400 is a handheld computer having both input elements and output elements. The mobile computing device 400 typically includes a display 405 and one or more input buttons 410 that allow the user to enter information into the mobile computing device 400. The display 405 of the mobile computing device 400 may also function as an input device (e.g., touch screen display). If included, an optional side input element 415 allows further user input. The side input element 415 may be a rotary switch, a button, or any other type of manual input element. In alternative examples, mobile computing device 400 may incorporate more or less input elements. For example, the display 405 may not be a touch screen in some examples. In yet another alternative example, the mobile computing device 400 is a portable phone system, such as a cellular phone. The mobile computing device 400 may also include an optional keypad 435. Optional keypad 435 may be a physical keypad or a “soft” keypad generated on the touch screen display or any other soft input panel (SIP). In various examples, the output elements include the display 405 for showing a GUI, a visual indicator 420 (e.g., a light emitting diode), and/or an audio transducer 425 (e.g., a speaker). In some examples, the mobile computing device 400 incorporates a vibration transducer for providing the user with tactile feedback. In yet another example, the mobile computing device 400 incorporates input and/or output ports, such as an audio input (e.g., a microphone jack), an audio output (e.g., a headphone jack), and a video output (e.g., a HDMI port) for sending signals to or receiving signals from an external device.

FIG. 4B is a block diagram illustrating the architecture of one example of a mobile computing device. That is, the mobile computing device 400 can incorporate a system (i.e., an architecture) 402 to implement some examples. In one examples, the system 402 is implemented as a “smart phone” capable of running one or more applications (e.g., browser, e-mail, calendaring, contact managers, messaging clients, games, and media clients/players). In some examples, the system 402 is integrated as a computing device, such as an integrated personal digital assistant (PDA), tablet and wireless phone.

One or more application programs 466 may be loaded into the memory 462 and run on or in association with the operating system 464. Examples of the application programs include phone dialer programs, e-mail programs, personal information management (PIM) programs, word processing programs, spreadsheet programs, Internet browser programs, messaging programs, and so forth. The system 402 also includes a non-volatile storage area 468 within the memory 462. The non-volatile storage area 468 may be used to store persistent information that should not be lost if the system 402 is powered down. The application programs 466 may use and store information in the non-volatile storage area 468, such as e-mail or other messages used by an e-mail application, and the like. A synchronization application (not shown) also resides on the system 402 and is programmed to interact with a corresponding synchronization application resident on a host computer to keep the information stored in the non-volatile storage area 468 synchronized with corresponding information stored at the host computer. As should be appreciated, other applications may be loaded into the memory 462 and run on the mobile computing device (e.g. system 402) described herein.

The system 402 has a power supply 470, which may be implemented as one or more batteries. The power supply 470 might further include an external power source, such as an AC adapter or a powered docking cradle that supplements or recharges the batteries.

The system 402 may include peripheral device port 430 that performs the function of facilitating connectivity between system 402 and one or more peripheral devices. Transmissions to and from the peripheral device port 430 are conducted under control of the operating system (OS) 464. In other words, communications received by the peripheral device port 430 may be disseminated to the application programs 466 via the operating system 464, and vice versa.

The system 402 may also include a radio interface layer 472 that performs the function of transmitting and receiving radio frequency communications. The radio interface layer 472 facilitates wireless connectivity between the system 402 and the “outside world,” via a communications carrier or service provider. Transmissions to and from the radio interface layer 472 are conducted under control of the operating system 464. In other words, communications received by the radio interface layer 472 may be disseminated to the application programs 566 via the operating system 464, and vice versa.

The visual indicator 420 may be used to provide visual notifications, and/or an audio interface 474 may be used for producing audible notifications via the audio transducer 425 (as described in the description of mobile computing device 400). In the illustrated example, the visual indicator 420 is a light emitting diode (LED) and the audio transducer 425 is a speaker. These devices may be directly coupled to the power supply 470 so that when activated, they remain on for a duration dictated by the notification mechanism even though the processor 460 and other components might shut down for conserving battery power. The LED may be programmed to remain on indefinitely until the user takes action to indicate the powered-on status of the device. The audio interface 474 is used to provide audible signals to and receive audible signals from the user. For example, in addition to being coupled to the audio transducer 425 (shown in FIG. 4A), the audio interface 474 may also be coupled to a microphone to receive audible input, such as to facilitate a telephone conversation. In accordance with examples of the present invention, the microphone may also serve as an audio sensor to facilitate control of notifications, as will be described below. The system 402 may further include a video interface 476 that enables an operation of an on-board camera 430 to record still images, video stream, and the like.

A mobile computing device 400 implementing the system 402 may have additional features or functionality. For example, the mobile computing device 400 may also include additional data storage devices (removable and/or non-removable) such as, magnetic disks, optical disks, or tape. Such additional storage is illustrated in FIG. 4B by the non-volatile storage area 468.

Data/information generated or captured by the mobile computing device 400 and stored via the system 402 may be stored locally on the mobile computing device 400, as described above, or the data may be stored on any number of storage media that may be accessed by the device via the radio 472 or via a wired connection between the mobile computing device 400 and a separate computing device associated with the mobile computing device 400, for example, a server computer in a distributed computing network, such as the Internet. As should be appreciated such data/information may be accessed via the mobile computing device 400 via the radio 472 or via a distributed computing network. Similarly, such data/information may be readily transferred between computing devices for storage and use according to well-known data/information transfer and storage means, including electronic mail and collaborative data/information sharing systems.

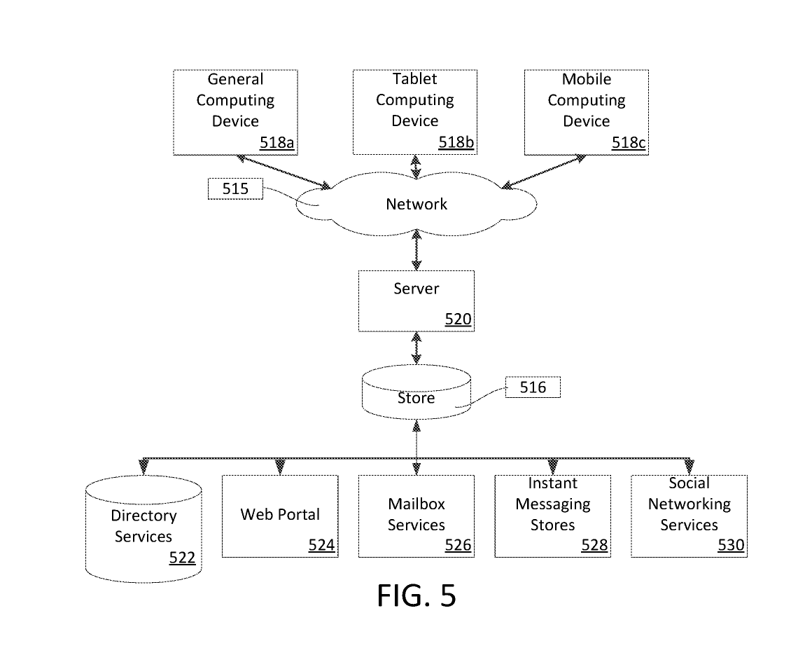

FIG. 5 illustrates one example of the architecture of a system for providing an application that reliably accesses target data on a storage system and handles communication failures to one or more client devices, as described above. The system of FIG. 5 may be an exemplary system configured for mapping between a vertical programming interface (API) and a horizontal API and related processing operations (including automated generation of an API) as described herein. Target data accessed, interacted with, or edited in association with programming modules 308 and/or applications 320 and storage/memory (described in FIG. 3) may be stored in different communication channels or other storage types. For example, various documents may be stored using a directory service 522, a web portal 524, a mailbox service 526, an instant messaging store 528, or a social networking site 530, I0 manager 324, other utility 326, application 328 and storage systems may use any of these types of systems or the like for enabling data utilization, as described herein. A server 520 may provide storage system for use by a client operating on general computing device 302 and mobile device(s) 400 through network 515. By way of example, network 515 may comprise the Internet or any other type of local or wide area network, and a client node may be implemented for connecting to network 515. Examples of a client node comprise but are not limited to: a computing device 302 embodied in a personal computer, a tablet computing device, and/or by a mobile computing device 400 (e.g., mobile processing device). As an example, a client node may connect to the network 515 using a wireless network connection (e.g. WiFi connection, Bluetooth, etc.). However, examples described herein may also extend to connecting to network 515 via a hardwire connection. Any of these examples of the client computing device 302 or 400 may obtain content from the store 516.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
accessing vertical application programming interface (API) construct data for generation of a vertical API, wherein the vertical API construct data is domain-specific;
mapping, in a single data layer, the vertical API construct data with horizontal API construct data for a horizontal API that is used by a plurality of services; and
automatically implementing the vertical API based on the mapping of the vertical API construct data with horizontal API construct data in the single data layer.

2. The method of claim 1, wherein the automatically implementing further comprises automatically generating the vertical API, on behalf of a developer, without the developer having to code the vertical API.

3. The method of claim 1, wherein the horizontal API is associated with one or more directory services, and wherein the vertical API is associated with a domain of the one or more directory services.

4. The method of claim 3, wherein the domain is an education-specific domain created within the one or more directory services.

5. The method of claim 1, further comprising: surfacing, in a service of the plurality of services, a domain for the vertical API based on the implementing.

6. The method of claim 1, wherein the mapping further comprises generating one or more transparent data containers for mapped parameters of the vertical API construct data with the horizontal API construct data, and wherein the automatically generating further comprises generating coding that associates the one or more transparent data containers with the generated vertical API.

7. The method of claim 6, wherein the single data layer is a data layer for the horizontal API construct data, and wherein the one or more transparent data containers are written into a data layer of the horizontal API construct data.

8. A system comprising:
at least one processor; and
a memory, operatively connected with the at least one processor, storing computer-executable instructions that, when executed by the at least one processor, causes the at least one processor to execute a method that comprises:
accessing vertical application programming interface (API) construct data for generation of a vertical API, wherein the vertical API construct data is domain-specific;
mapping, in a single data layer, the vertical API construct data with horizontal API construct data for a horizontal API that is used by a plurality of services; and
automatically implementing the vertical API based on the mapping of the vertical API construct data with horizontal API construct data in the single data layer.

9. The system of claim 8, wherein the vertical API is automatically generated, on behalf of a developer, without the developer having to code the vertical API.

10. The system of claim 8, wherein the horizontal API is associated with one or more directory services, and wherein the vertical API is associated with a domain of the one or more directory services.

11. The system of claim 10, wherein the domain is an education-specific domain created within the one or more directory services.

12. The system of claim 8, wherein the method, executed by the at least one processor, further comprises: surfacing, in a service of the plurality of services, a domain for the vertical API based on the implementing.

13. The system of claim 8, wherein the mapping further comprises generating one or more transparent data containers for mapped parameters of the vertical API construct data with the horizontal API construct data, and wherein the automatically generating further comprises generating coding that associates the one or more transparent data containers with the generated vertical API.

14. The system of claim 13, wherein the single data layer is a data layer for the horizontal API construct data, and wherein the one or more transparent data containers are written into a data layer of the horizontal API construct data.

15. A computer-readable storage medium storing computer-executable instructions that, when executed by at least one processor, causes the at least one processor to execute a method comprising:
accessing vertical application programming interface (API) construct data for generation of a vertical API, wherein the vertical API construct data is domain-specific;
mapping, in a single data layer, the vertical API construct data with horizontal API construct data for a horizontal API that is used by a plurality of services; and
automatically implementing the vertical API based on the mapping of the vertical API construct data with horizontal API construct data in the single data layer.

16. The computer-readable storage medium of claim 15, wherein the vertical API is automatically generated, on behalf of a developer, without the developer having to code the vertical API.

17. The computer-readable storage medium of claim 15, wherein the horizontal API is associated with one or more directory services, and wherein the vertical API is associated with a domain of the one or more directory services.

18. The computer-readable storage medium of claim 15, wherein the executed method further comprising: surfacing, in a service of the plurality of services, a domain for the vertical API based on the implementing.

19. The computer-readable storage medium of claim 15, wherein the mapping further comprises generating one or more transparent data containers for mapped parameters of the vertical API construct data with the horizontal API construct data, and wherein the automatically generating further comprises generating coding that associates the one or more transparent data containers with the generated vertical API.

20. The computer-readable storage medium of claim 19, wherein the single data layer is a data layer for the horizontal API construct data, and wherein the one or more transparent data containers are written into a data layer of the horizontal API construct data.
